(19) United States
(12) Patent Application Publication
(10) Pub. No.: US 2025/0168297 A1
(43) Pub. Date: May 22, 2025

(54) VIDEO CONFERENCE SYSTEM AND VIDEO CONFERENCE METHOD

(71) Applicant: PEGATRON CORPORATION, TAIPEI CITY (TW)

(72) Inventors: CHEN-HAO WU, TAIPEI CITY (TW); SHIN-CHUAN LEE, TAIPEI CITY (TW)

(21) Appl. No.: 18/921,009

(22) Filed: Oct. 21, 2024

(30) Foreign Application Priority Data
Nov. 22, 2023 (TW) 112145050

(51) Int. Cl. H04N 7/15; G06V 10/46; G06V 20/70; G06V 40/16

(52) U.S. Cl. CPC H04N 7/152; G06V 10/46; G06V 20/70; G06V 40/168

(57) ABSTRACT

A video conference system and a video conference method are provided. The video conference system includes a master conference device and a slave conference device. The master conference device captures a master image that includes a speaker and crops out a master image of the speaker from the master panoramic image. The slave conference device captures a slave panoramic image that includes the speaker, and crops out a slave image of the speaker from the slave panoramic image. The master conference device compares the master image with the slave image to generate a comparison result, and transmits one of the master image and the slave image to a remote user device according to the comparison result.

### CROSS-REFERENCE TO RELATED PATENT APPLICATION

This application claims the benefit of priority to Taiwan Patent Application No. 112145050, filed on Nov. 22, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a conference system and a conference method, and more particularly to a video conference system and a video conference method.

### BACKGROUND OF THE DISCLOSURE

Conventionally, video conference devices have a wide-angle view of all corners of a conference room. However, the existing video conference devices have distance and angle limits in terms of person recognition and voice orientation recognition. Therefore, the maximum area that can be covered by one single video conference device is about 4.5 meters*6 meters. In order to cover a larger area, it is common to form a series connection between first and second video conference devices located in the conference room.

Regarding the operation between the first and second video conference devices, the first video conference device captures all participants in the conference room to capture a panoramic image, and then transmits the panoramic image to the second video conference device. When receiving the panoramic image from the first video conference device, the second video conference device performs person recognition on the panoramic image.

Since the size of the panoramic image is large, transmission of the panoramic image from the first video conference device to the second video conference device can be time-consuming. In addition, due to the large size of the panoramic image, when the second video conference device performs person recognition on the panoramic image, a heavy computing load is imposed on the second video conference device. As a result, when a video conference is held with a user at a remote end, a video image is likely to be lagged.

### SUMMARY OF THE DISCLOSURE

In response to the above-referenced technical inadequacy, the present disclosure provides a video conference system and a video conference method.

In order to solve the above-mentioned problem, one of the technical aspects adopted by the present disclosure is to provide a video conference system. The video conference system is connected to a remote user device via a network, and includes a master conference device via a network. The video conference system includes a master conference device and a slave conference device. The master conference device is configured to capture a master panoramic image that includes a speaker, recognize a master image of the speaker in the master panoramic image, and crop out the master image from the master panoramic image. The slave conference device is coupled to the master conference device. The slave conference device is configured to capture a slave panoramic image that includes the speaker, recognize a slave image of the speaker in the slave panoramic image, and crop out the slave image from the slave panoramic image. The slave conference device transmits the slave image to the master conference device. The master conference device compares the master image with the slave image to generate a comparison result and transmits one of the master image and the slave image to remote user device according to the comparison result.

In order to solve the above-mentioned problem, another one of the technical aspects adopted by the present disclosure is to provide a video conference method. The video conference method includes: capturing a master panoramic image that includes a speaker by a master conference device; recognizing a master image of the speaker in the master panoramic image by the master conference device; cropping out the master image of the speaker from the master panoramic image by the master conference device; capturing a slave panoramic image that includes the speaker by a slave conference device; recognizing a slave image of the speaker in the slave panoramic image by the slave conference device; cropping out the slave image of the speaker from the slave panoramic image by the slave conference device; comparing, by the master conference device, the master image with the slave image to generate a comparison result; and transmitting, by the master conference device, one of the master image and the slave image to a remote user device according to the comparison result.

Therefore, in the video conference system and the video conference method provided by the present disclosure, the slave conference device only transmits a portrait image of a panoramic image to the master conference device, thereby significantly reducing a transmission time of image data. In addition, the master conference device makes a comparison based on a contour of the portrait image, such that a computing load of the master conference device is reduced. By reducing the transmission time of the image data and the computing load of the master conference device, the problem of image delay can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a video conference system in use according to the present disclosure;

FIG. 2 is a functional block diagram of the video conference system according to a first embodiment of the present disclosure;

FIG. 3 is a schematic diagram showing a master panoramic image captured by a master conference device;

FIG. 4 is a schematic diagram showing person recognition performed by the master conference device;

FIG. 5 is a schematic diagram showing a speaker marked by the master conference device;

FIG. 6 is a schematic diagram showing a slave panoramic image captured by a slave conference device;

FIG. 7 is a schematic diagram showing person recognition performed by the slave conference device;

FIG. 8 is a schematic diagram showing the speaker marked by the slave conference device;

FIG. 9 is a schematic diagram showing identity labels added by the master conference device;

FIG. 10 is a flowchart of a video conference method applied to the video conference system of FIG. 2 according to the first embodiment of the present disclosure; and

FIGS. 11A and 11B are a flowchart of the video conference method applied to the video conference system of FIG. 2 according to a second embodiment of the present disclosure.

### DETAILED DESCRIPTION OF THE EXEMPLARY EMBODIMENTS

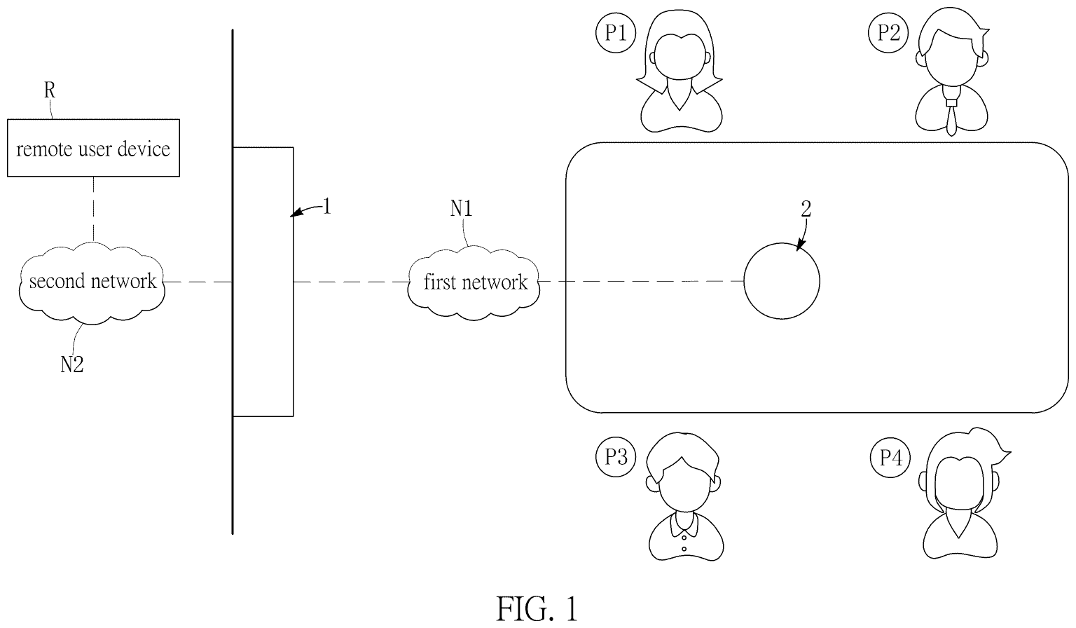

FIG. 1 is a schematic diagram of a video conference system in use according to the present disclosure. Referring to FIG. 1, the video conference system is arranged in a local conference room, and there are four participants P1 to P4 in the local conference room. The video conference system includes a master conference device 1 and a slave conference device 2, and the master conference device 1 is coupled to the slave conference device 2. In this embodiment, the master conference device 1 and the slave conference device 2 are coupled via a first network N1. The master conference device 1 and a remote user device R are coupled via a second network N2. The remote user device R is, for example, a computer host, a mobile communication device, or a server, and the remote user device R executes video conference software, such as ZOOM, TEAM, or GOOGLE MEET. In other embodiments of the present disclosure, the master conference device 1 and the slave conference device 2 can also transmit data through physical network lines, buses, or any transmission interface, but the present disclosure is not limited thereto.

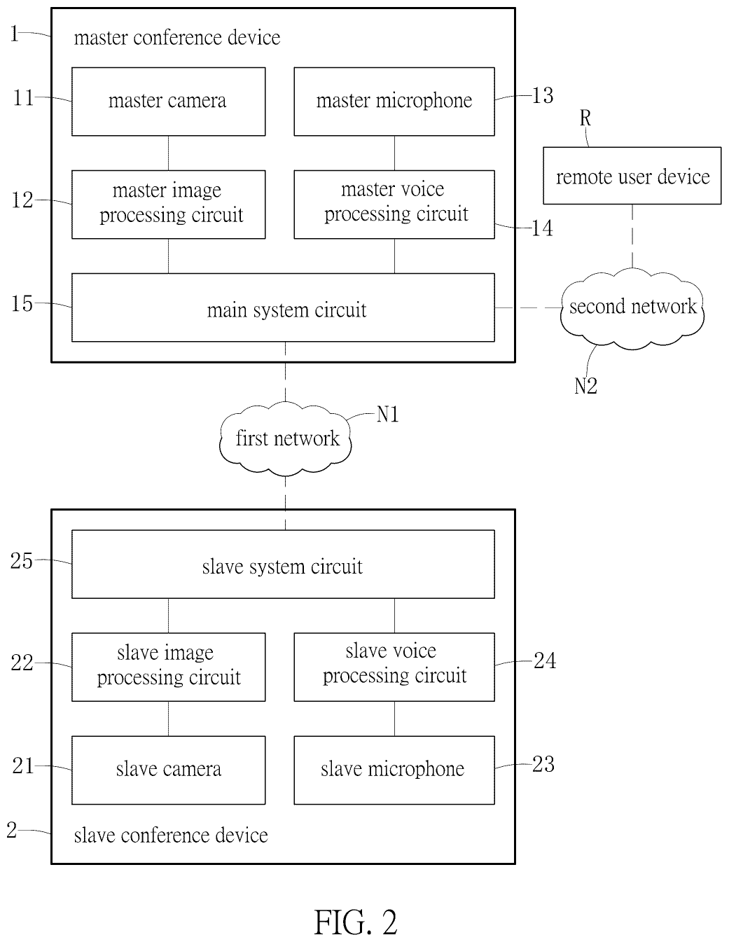

FIG. 2 is a functional block diagram of the video conference system according to a first embodiment of the present disclosure. Referring to FIG. 2, the master conference device 1 includes a master camera 11, a master image processing circuit 12, a master microphone 13, a master voice processing circuit 14, and a master system circuit 15. The master camera 11 is electrically connected to the master image processing circuit 12. A field of view (FOV) of the master camera 11 is, for example, 180 degrees, and the master camera 11 is configured to capture a master panoramic image. The master microphone 13 may be a microphone array and is coupled to the master voice processing circuit 14. The master image processing circuit 12 and the master voice processing circuit 14 are coupled to the master system circuit 15. The slave conference device 2 includes a slave camera 21, a slave image processing circuit 22, a slave microphone 23, a slave voice processing circuit 24, and a slave system circuit 25. The slave camera 21 is coupled to the slave image processing circuit 22. A field of view of the slave camera 21 is, for example, 360 degrees, and the slave camera 21 is configured to capture a slave panoramic image. The slave microphone 23 may be a microphone array and is coupled to the slave voice processing circuit 24. The slave image processing circuit 22 and the slave voice processing circuit 24 are coupled to the slave system circuit 25. The master system circuit 15 of the master conference device 1 and the slave system circuit 25 of the slave conference device 2 are coupled via the first network N1.

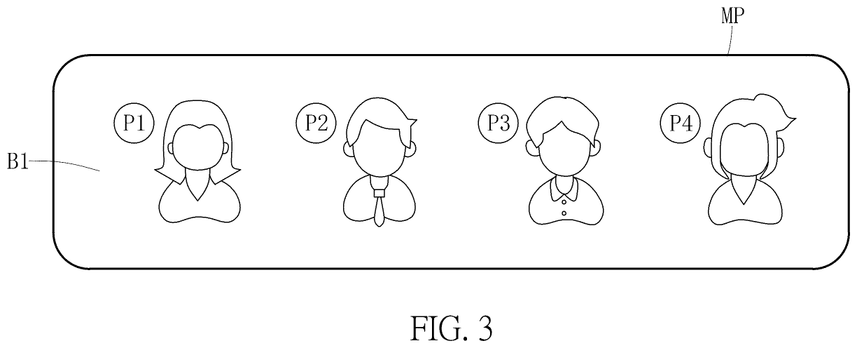

FIG. 3 is a schematic diagram showing a master panoramic image MP captured by the master conference device 1. As shown in FIG. 3, the master camera 11 of the master conference device 1 shoots the four participants P1˜P4 to capture the master panoramic image MP, and the master panoramic image MP includes a first background B1 and the four participants P1˜P4.

The master image processing circuit 12 is, for example, a neural network processing unit (NPU), and the master image processing circuit 12 is coupled to the master camera 11. When the master image processing circuit 12 captures the master panoramic image MP, the master image processing circuit 12 is configured to perform person recognition on the master panoramic image MP.

Specifically, the master image processing circuit 12 can perform person recognition through computer vision or an artificial intelligence deep learning model, so as to identify human features of the master panoramic image MP. For example, the computer vision can identify the participants P1˜P4 in the master panoramic image MP through differences between person contours and the first background B1. The deep learning model is, for example, implemented by a deep learning network, such as a convolutional neural network (CNN). The convolutional neural network is, for example, formed by one or more convolution layers, one or more pooling layers, and one or more fully connected layers. A front end of the convolutional neural network is formed by the convolution layer and the pooling layer connected in series or in parallel and is used to extract feature values of an image. The fully connected layer classifies objects in the image based on the feature values generated through the convolution layer and the pooling layer and obtain object information corresponding to the recognized objects. The object information includes a bounding box for enclosing the recognized object and also includes the type of the recognized object.

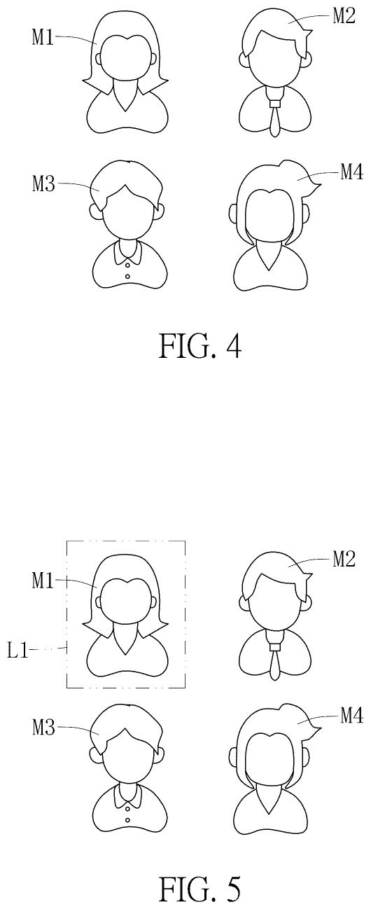

FIG. 4 is a schematic diagram showing person recognition performed by the master conference device 1. Referring to FIG. 4, the master image processing circuit 12 of the master conference device 1 crops out master images M1˜M4 from the master panoramic image MP.

The master microphone 13 is coupled to the master voice processing circuit 14 for receiving audio data generated by one or more audio sources. The master voice processing circuit 14 (e.g., an audio digital signal processor (audio DSP)) performs voice activity detection (VAD) and direction of arrival (DOA) on the audio data of the master microphone 13, so as to generate master voice activity data and master voice orientation data. The master voice activity data includes human voice of the audio data of the master microphone 13, and the master voice orientation data includes a direction and a relative angle of the audio source.

The master system circuit 15 includes, for example, a central processing unit, a controller, a graphics processor, a memory, and a wireless communication processing circuit, which can be implemented in a system on chip (SOC). The master system circuit 15 is coupled to the master image processing circuit 12 and the master voice processing circuit 14, so as to obtain the master images M1˜M4, the audio data of the master microphone 13, the master voice activity data, and the master voice orientation data.

Referring to FIG. 1, FIG. 4, and FIG. 5, FIG. 5 is a schematic diagram showing a speaker marked by the master conference device 1. As shown in FIG. 1, four different relative angles are correspondingly formed between the master conference device 1 and the participants P1˜P4. After the master system circuit 15 captures the master images M1˜M4, the master voice activity data, and the master voice orientation data, the master system circuit 15 compares the four relative angles with the master voice orientation data. When the master system circuit 15 determines that the master voice orientation data is consistent with at least one of the four relative angles, the master system circuit 15 determines that at least one of the participants P1˜P4 is the speaker. If the master conference device 1 determines that the participant P1 is the speaker, the master conference device 1 marks the first master image M1 corresponding to the participant P1 with a speaker label L1.

When the master conference device 1 determines that the master voice orientation data matches the two relative angles between the master conference device 1 and the participants P1˜P2, the master conference device 1 determines that the participants P1˜P2 are the speakers, and marks each of the master image M1 and the master image M2 with the speaker label L1 (not shown in the figures).

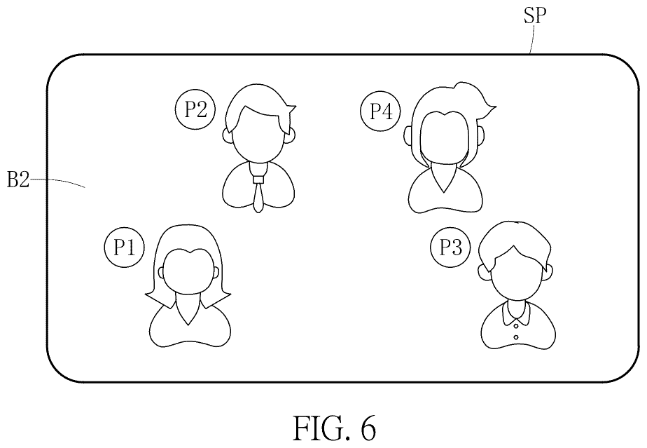

FIG. 6 is a schematic diagram showing a slave panoramic image SP captured by the slave conference device 2. As shown in FIG. 6, the slave camera 21 of the slave conference device 2 shoots the four participants P1˜P4 to capture the slave panoramic image SP, and the slave panoramic image SP includes a second background B2 and the four participants P1˜P4.

The slave image processing circuit 22 is, for example, a neural network processor, and the slave image processing circuit 22 is coupled to the slave camera 21. The slave image processing circuit 22 is configured to perform person recognition on the slave panoramic image SP. In this embodiment, the slave image processing circuit 22 is the same as the master image processing circuit 12. For relevant details, reference can be made to the descriptions above, which will not be reiterated herein.

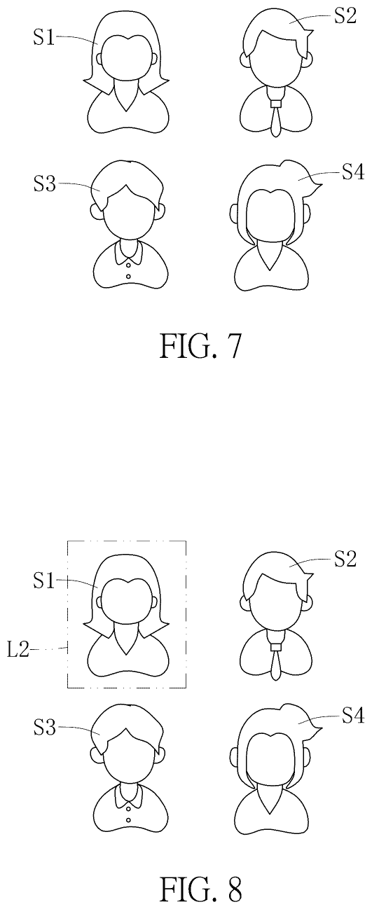

FIG. 7 is a schematic diagram showing recognition performed by the slave conference device 2. Referring to FIG. 7, the slave image processing circuit 22 of the slave conference device 2 crops out slave images S1˜S4 from the slave panoramic image SP.

The slave microphone 23 is coupled to the slave voice processing circuit 24 for receiving audio data generated by one or more audio sources. The slave voice processing circuit 24 (e.g., a voice digital signal processor) performs voice activity detection and voice orientation detection on the audio data of the slave microphone 23, so as to generate slave voice activity data and slave voice orientation data.

The slave system circuit 25 includes, for example, a central processing unit, a controller, a graphics processor, a memory, and a wireless communication processing circuit, which can be implemented in a system on chip. The slave system circuit 25 is coupled to the slave image processing circuit 22 and the slave voice processing circuit 24, so as to obtain the slave images S1˜S4, the slave voice activity data, and the slave voice orientation data.

Referring to FIG. 1, FIG. 7, and FIG. 8, FIG. 8 is a schematic diagram showing the speaker marked by the slave conference device 2. As shown in FIG. 1, four different relative angles are correspondingly formed between the slave conference device 2 and the participants P1˜P4. After the slave system circuit 25 captures the slave images S1˜S4, the slave voice activity data, and the slave voice orientation data, the slave system circuit 25 compares the four relative angles with the slave voice orientation data. When the slave system circuit 25 determines that the slave voice orientation data is consistent with at least one of the four relative angles, the slave system circuit 25 determines that at least one of the participants P1˜P4 is the speaker. If the slave conference device 2 determines that the participant P1 is the speaker, the slave conference device 2 marks the slave image S1 corresponding to the participant P1 with a speaker label L2.

When the slave conference device 2 determines that the slave voice orientation data matches the relative angle between the participant P1 and the slave conference device 2 and the relative angle between the participant P2 and the slave conference device 2, the slave conference device 2 determines that the participants P1˜P2 are the speakers, and marks each of the slave images S1 to S2 with the speaker label L2 (not shown in the figures).

After the slave conference device 2 completes a speaker marking process, the slave system circuit 25 of the slave conference device 2 transmits the slave images S1˜S4, slave audio data, the slave voice activity data, and the slave voice orientation data to the master system circuit 15 of the master conference device 1.

Regarding transmission of image data, since the slave conference device 2 only transmits the slave image of the panoramic image to the master conference device 1 (instead of transmitting the whole panoramic image to the master conference device 1), transmission time for the image data is reduced.

The master system circuit 15 is configured to compare the master images M1˜M4 individually with the slave images S1˜S4, and marks a master image and a slave image having the same contour with the same identity label according to a comparison result.

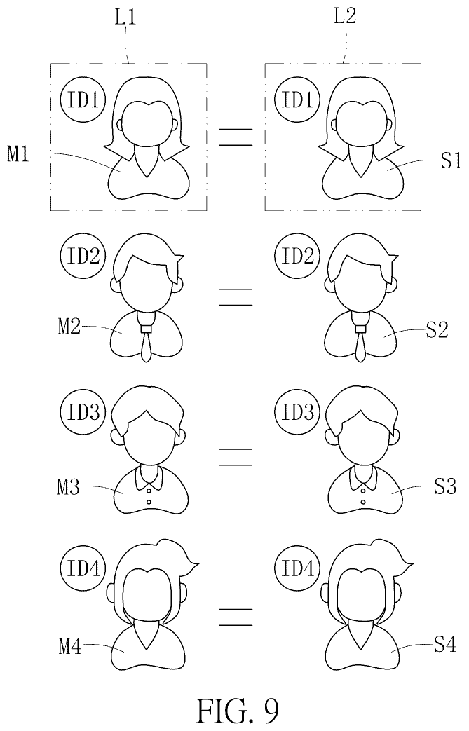

FIG. 9 is a schematic diagram showing the identity labels marked by the master conference device 1. Referring to FIG. 9, the master system circuit 15 of the master conference device 1 determines that the master image M1 and the slave image S1 have the same contour. The master system circuit 15 marks both the master image M1 and the slave image S1 with the first identity label ID1, so as to form a first person recognition group. The master system circuit 15 determines that the master image M2 and the slave image S2 have the same contour, and marks both the master image M2 and the slave image S2 with the second identity label ID2, so as to form a second person recognition group. The master system circuit 15 determines that the master image M3 and the slave image S3 have the same contour, and marks both the master image M3 and slave image S3 with the third identity label ID3, so as to form a third person recognition group. The master system circuit 15 determines that the master image M4 and the slave image S4 have the same outer contour, and marks both the master image M4 and the slave image S4 with the fourth identity label ID4, so as to form a fourth person recognition group.

Since the master conference device 1 only needs to compare the contours of the portrait images (instead of comparing the whole panoramic images), a computing load of the master conference device 1 is reduced.

The master system circuit 15 of the master conference device 1 is configured to determine whether facial features of the master image and the slave image in each of person recognition groups meet frontal face criteria according to frontal face determination procedure. When the facial features of the master image in each of the person recognition groups meet the frontal face criteria, the master system circuit 15 transmits the master image in each of the person recognition groups to the remote user device R. When the facial features of the slave image in each of the person recognition groups meet the frontal face criteria, the master system circuit 15 transmits the slave image in each of the person recognition groups to the remote user device R. When the facial features of the master image and the slave image in each of the person recognition groups meet the frontal face criteria, the master system circuit 15 transmits the master image or the slave image in each of the person recognition groups to the remote user device R.

For example, in the frontal face determination procedure, the center of the left eye, the center of the right eye, the right end of the lip, the left end of the lip, and the tip of the nose are defined as a left eye reference point, a right eye reference point, a right end reference point of the lip, a left end reference point of the lip, and a reference point of the tip of the nose. A first straight line is connected between the left eye reference point and the right end reference point of the lip. A second straight line is connected between the right eye reference point and the left end reference point of the lip. An intersection point of the first straight line and the second straight line is defined as the center of a circle, a radius of which=(a height of a face candidate frame+a width of the face candidate frame)*a default ratio. When the reference point of the tip of the nose is within the circle, it means that the facial features meet the frontal face criteria.

On the other hand, when the master system circuit 15 of the master conference device 1 receives the audio data from the slave microphone 23, the master system circuit 15 compares gain of the audio data of the master microphone 13 with gain of the audio data of the slave microphone 23 When the gain of the audio data of the master microphone 13 is greater than that of the slave microphone 23, the master system circuit 15 transmits the audio data of the master microphone 13 to the remote user device R. When the gain of the audio data of the slave microphone 23 is greater than that of the master microphone 13, the master system circuit 15 transmits the audio data of the slave microphone 23 to the remote user device R.

Since the audio data of the master microphone 13 and the audio data of the slave microphone 23 at a local end are consensually transmitted to the remote user device R through the master conference device 1, a crosstalk phenomenon does not occur.

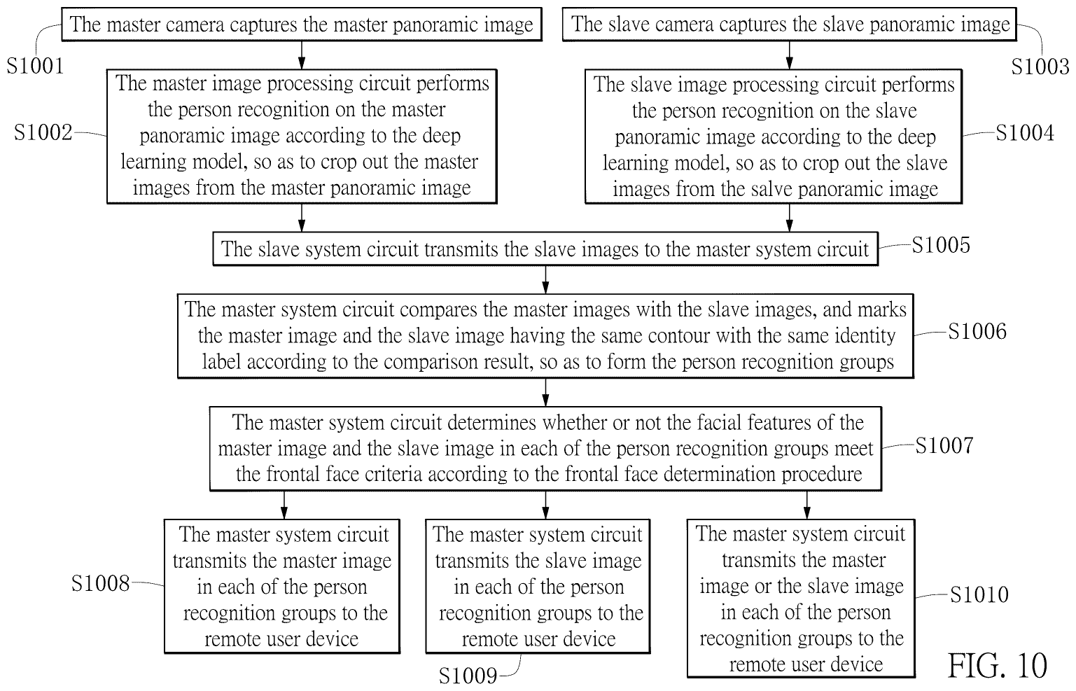

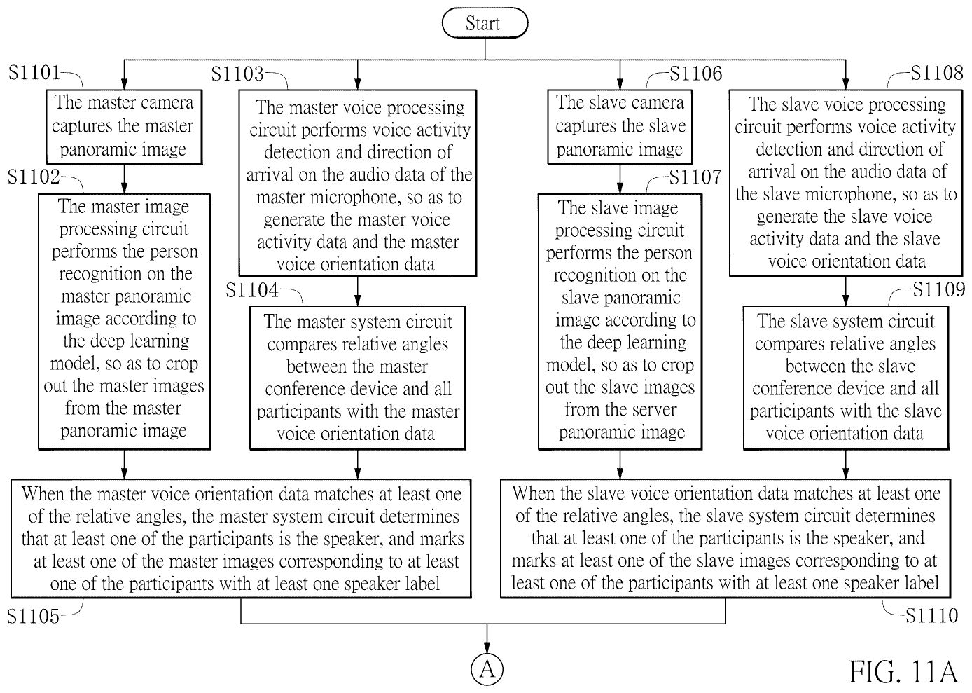

FIG. 10 is a flowchart of a video conference method applied to the video conference system of FIG. 2 according to a first embodiment of the present disclosure. Referring to FIG. 10, in step S1001, the master camera 11 captures the master panoramic image. In step S1002, the master image processing circuit 12 performs the person recognition on the master panoramic image according to the deep learning model, so as to crop out the master images from the master panoramic image.

In step S1003, the slave camera 21 captures the slave panoramic image. In step S1004, the slave image processing circuit 22 performs the person recognition on the slave panoramic image according to the deep learning model, so as to crop out the slave images from the salve panoramic image. In step S1005, the slave system circuit 25 transmits the slave images to the master system circuit 15. In step S1006, the master system circuit 15 compares the master images with the slave images, and marks the master image and the slave image having the same contour with the same identity label according to the comparison result, so as to form the person recognition groups. The person recognition groups correspond to respective identity labels, and each of the person recognition groups includes the master image and the slave image. In step S1007, the master system circuit 15 determines whether or not the facial features of the master image and the slave image in each of the person recognition groups meet the frontal face criteria according to the frontal face determination procedure. When the facial features of the master image in each of the person recognition groups meet the frontal face criteria, step S1007 is followed by step S1008. When the facial features of the slave image in each of the person recognition groups meet the frontal face criteria, step S1007 is followed by step S1009. When the facial features of the master image and the slave image in each of the person recognition groups meet the frontal face criteria, step S1007 is followed by step S1010.

In step S1008, the master system circuit 15 transmits the master image in each of the person recognition groups to the remote user device R. In step S1009, the master system circuit 15 transmits the slave image in each of the person recognition groups to the remote user device R. In step S1010, the master system circuit 15 transmits the master image or the slave image in each of the person recognition groups to the remote user device R.

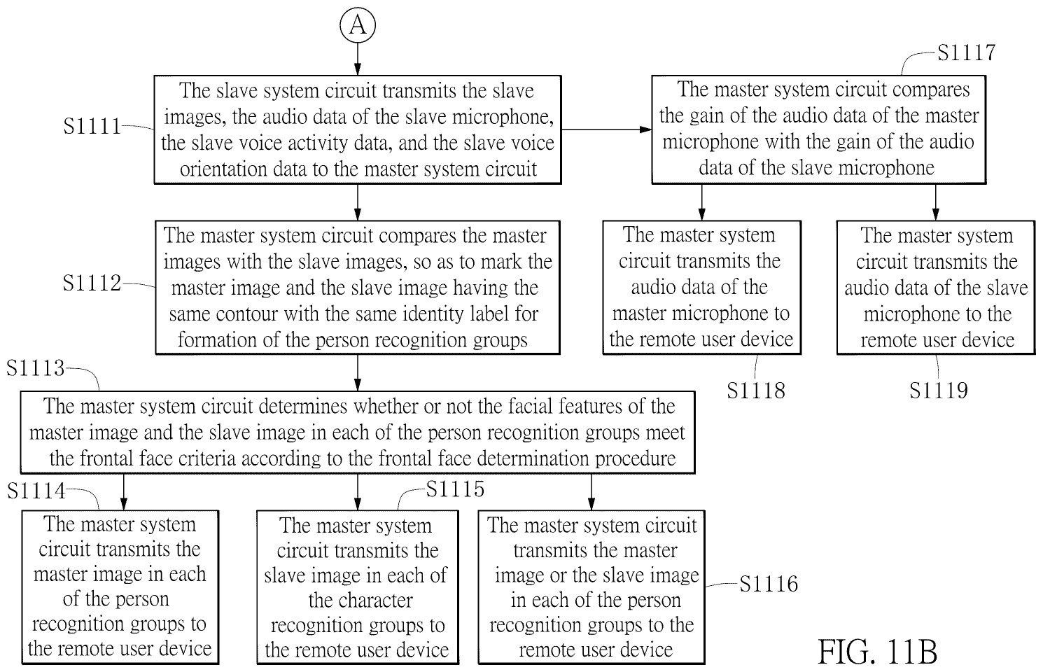

FIGS. 11A and 11B are a flowchart of a video conference method applied to the video conference system of FIG. 2 according to a second embodiment of the present disclosure. Referring to FIG. 11A, in step S1101, the master camera 11 captures the master panoramic image. In step S1102, the master image processing circuit 12 performs the person recognition on the master panoramic image according to the deep learning model, so as to crop out the master images from the master panoramic image. In step S1103, the master voice processing circuit 14 performs voice activity detection and direction of arrival on the audio data of the master microphone 13, so as to generate the master voice activity data and the master voice orientation data. In step S1104, the master system circuit 15 compares relative angles between the master conference device 1 and all participants with the master voice orientation data. In step S1105, when the master voice orientation data matches at least one of the relative angles, the master system circuit 15 determines that at least one of the participants is the speaker, and marks at least one of the master images corresponding to at least one of the participants with at least one speaker label.

Referring to FIG. 11A, in step S1106, the slave camera 21 captures the slave panoramic image. In step S1107, the slave image processing circuit 22 performs the person recognition on the slave panoramic image according to the deep learning model, so as to crop out the slave images from the server panoramic image. In step S1108, the slave voice processing circuit 24 performs voice activity detection and direction of arrival on the audio data of the slave microphone 23, so as to generate the slave voice activity data and the slave voice orientation data. In step S1109, the slave system circuit 25 compares relative angles between the slave conference device 2 and all participants with the slave voice orientation data. In step S1110, when the slave voice orientation data matches at least one of the relative angles, the slave system circuit 25 determines that at least one of the participants is the speaker, and marks at least one of the slave images corresponding to at least one of the participants with at least one speaker label.

Referring to FIG. 11B, in step S1111, the slave system circuit 25 transmits the slave images, the audio data of the slave microphone 23, the slave voice activity data, and the slave voice orientation data to the master system circuit 15. In step S1112, the master system circuit 15 compares the master images with the slave images, so as to mark the master image and the slave image having the same contour with the same identity label for formation of the person recognition groups. The person recognition groups correspond to respective identity labels, and each of the person recognition groups includes the master image and the slave image.

In step S1113, the master system circuit 15 determines whether or not the facial features of the master image and the slave image in each of the person recognition groups meet the frontal face criteria according to the frontal face determination procedure. When the facial features of the master image in each of the person recognition groups meet the frontal face criteria, step S1113 is followed by step S1114. When the facial features of the slave image in each of the person recognition groups meet the frontal face criteria, step S1113 is followed by step S1115. When the facial features of the master image and the slave image in each of the person recognition groups meet the frontal face criteria, step S1113 is followed by step S1116.

In step S1114, the master system circuit 15 transmits the master image in each of the person recognition groups to the remote user device R. In step S1115, the master system circuit 15 transmits the slave image in each of the character recognition groups to the remote user device R. In step S1116, the master system circuit 15 transmits the master image or the slave image in each of the person recognition groups to the remote user device R.

When the remote user device R receives images of local participants, a first data column of a video conference interface on the remote user device R may display the images of all of the local participants, and a second data column of the video conference interface only displays an image of the speaker. The image display methods mentioned above are only examples, and the present disclosure is not limited thereto.

In step S1117, the master system circuit 15 compares the gain of the audio data of the master microphone 13 with the gain of the audio data of the slave microphone 23. When the gain of the audio data of the master microphone 23 is greater than that of the slave microphone 23, step S1117 is followed by S1118. When the gain of the audio data of the slave microphone 23 is greater than that of the master microphone 13, step S1117 is followed by step S1119. In step S1118, the master system circuit 15 transmits the audio data of the master microphone 13 to the remote user device R. In step S1119. The master system circuit 15 transmits the audio data of the slave microphone 23 to the remote user device R.

### Beneficial Effects of the Embodiments

In conclusion, in the video conference system and the video conference method provided by the present disclosure, the slave conference device only transmits the slave image of the panoramic image to the master conference device, thereby significantly reducing the transmission time of the image data. In addition, the master conference device makes a comparison based on the contour of the portrait image, such that the computing load of the master conference device is reduced. By reducing the transmission time of the image data and the computing load of the master conference device, the problem of image delay can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A video conference system, which is connected to a remote user device via a network, the video conference system comprising:
a master conference device, wherein the master conference device is configured to capture a master panoramic image that includes a speaker, recognize a master image of the speaker in the master panoramic image, and crop out the master image from the master panoramic image; and
a slave conference device coupled to the master conference device, wherein the slave conference device is configured to capture a slave panoramic image that includes the speaker, recognize a slave image of the speaker in the slave panoramic image, and crop out the slave image from the slave panoramic image;
wherein the slave conference device transmits the slave image to the master conference device, the master conference device compares the master image with the slave image to generate a comparison result, and the master conference device transmits one of the master image and the slave image to the remote user device according to the comparison result.

2. The video conference system according to claim 1, wherein, when the comparison result indicates that the master image and the slave image have a same contour, the master conference device marks the master image and the slave image with a same identity label.

3. The video conference system according to claim 2, wherein the master conference device determines whether or not facial features of the master image and facial features of the slave image meet frontal face criteria; wherein, when the facial features of the master image meet the frontal face criteria, the master conference device transmits the master image to the remote user device, and when the facial features of the slave image meet the frontal face criteria, the master conference device transmits the slave image to the remote user device.

4. The video conference system according to claim 1, wherein at least one relative angle is formed between the speaker and at least one of the master conference device and the slave conference device; wherein at least one of the master conference device and the slave conference device receives voice data of a participant, and recognizes an orientation of the voice data of the participant, so as to generate master voice orientation data; wherein at least one of the master conference device and the slave conference device compares the at least one relative angle with the master voice orientation data; wherein, when the master voice orientation data matches the at least one relative angle, at least one of the master conference device and the slave conference device determines that the participant is the speaker, and marks at least one of the master image and the slave image with a speaker label.

5. The video conference system according to claim 1, wherein the master conference device further includes a master microphone, the slave conference device further includes a slave microphone, and the master conference device compares gain of audio data of the master microphone with gain of audio data of the slave microphone; wherein, when the gain of the audio data of the master microphone is greater than the gain of the audio data of the slave microphone, the master conference device transmits the audio data of the master microphone to the remote user device; and when the gain of the audio data of the slave microphone is greater than the gain of the audio data of the master microphone, the slave conference device transmits the audio data of the slave microphone to the remote user device.

6. A video conference method, comprising:
capturing, by a master conference device, a master panoramic image that includes a speaker;
recognizing, by the master conference device, a master image of the speaker in the master panoramic image;
cropping out, by the master conference device, the master image of the speaker from the master panoramic image;
capturing, by a slave conference device, a slave panoramic image that includes the speaker;
recognizing, by the slave conference device, a slave image of the speaker in the slave panoramic image;
cropping out, by the slave conference device, the slave image of the speaker from the slave panoramic image;
comparing, by the master conference device, the master image with the slave image to generate a comparison result; and
transmitting, by the master conference device, one of the master image and the slave image to a remote user device according to the comparison result.

7. The video conference method according to claim 6, further comprising: marking, by the master conference device, the master image and the slave image with a same identity label when the comparison result indicates that the master image and the slave image have a same contour.

8. The video conference method according to claim 7, wherein the master conference device determines whether or not facial features of the master image and facial features of the slave image meet frontal face criteria; wherein, when the facial features of the master image meet the frontal face criteria, the master conference device transmits the master image to the remote user device, and when the facial features of the slave image meet the frontal face criteria, the master conference device transmits the slave image to the remote user device.

9. The video conference method according to claim 6, further comprising: receiving, by at least one of the master conference device and the slave conference device, voice data of a participant; recognizing an orientation of the voice data of the participant by at least one of the master conference device and the slave conference device, so as to generate master voice orientation data; comparing, by at least one of the master conference device and the slave conference device, the master voice orientation data with at least one relative angle formed between the speaker and at least one of the master conference device and the slave conference device; and determining, by at least one of the master conference device and the slave conference device, that the participant is the speaker and marking at least one of the master image and the slave image with a speaker label when the master voice orientation data matches the at least one relative angle.

10. The video conference method according to claim 6, further comprising: comparing, by the master conference device, gain of audio data of a master microphone with gain of audio data of a slave microphone; and transmitting, by the master conference device, the audio data of the master microphone to the remote user device when the gain of the audio data of the master microphone is greater than the gain of the audio data of the slave microphone, or transmitting, by the slave conference device, the audio data of the slave microphone to the remote user device when the gain of the audio data of the slave microphone is greater than the gain of the audio data of the master microphone.
